(19) United States
(12) Patent Application Publication
(10) Pub. No.: US 2026/0086433 A1
(43) Pub. Date: Mar. 26, 2026

(54) OPTICAL ELEMENT DRIVE DEVICE AND CAMERA MODULE

(71) Applicant: ALPS ALPINE CO., LTD., Tokyo (JP)

(72) Inventor: Junichiro YOKOTA, Miyagi (JP)

(21) Appl. No.: 19/327,245

(22) Filed: Sep. 12, 2025

(30) Foreign Application Priority Data
Sep. 20, 2024 (JP) 2024-164049

(51) Int. Cl. G03B 13/36

(52) U.S. Cl. CPC G03B 13/36

(57) ABSTRACT

An optical element drive device includes: a support; an optical element holder provided with an opening capable of disposing therein an optical element and configured to move in a predetermined direction along a predetermined axis relative to the support; a driver including a shape-memory alloy wire to move the optical element holder in the predetermined direction; and an intermediate member provided between the optical element holder and the support, wherein the intermediate member is movable relative to the support and movable relative to the optical element holder, and the shape-memory alloy wire includes a first wire provided between the support and the intermediate member, and a second wire provided between the intermediate member and the optical element holder.

### CROSS-REFERENCE TO RELATED APPLICATIONS

The present application is based on and claims priority to Japanese Patent Application No. 2024-164049 filed on September 20, 2024, the entire contents of which are hereby incorporated by reference.

### BACKGROUND

### 1. Field of the Invention

The present disclosure relates to an optical element drive device and a camera module.

### 2. Description of the Related Art

Conventionally, there has been known a lens drive device configured to move a lens holder in a direction along an optical-axis while rotating the lens holder about the optical-axis with respect to a supporting structure by a shape-memory alloy wire (see International Publication No. WO2021-240165).

### SUMMARY

An optical element drive device according to an embodiment of the present disclosure includes: a support; an optical element holder provided with an opening capable of disposing therein an optical element and configured to move in a predetermined direction along a predetermined axis relative to the support; a driver including a shape-memory alloy wire to move the optical element holder in the predetermined direction; and an intermediate member provided between the optical element holder and the support, wherein the intermediate member is movable relative to the support and movable relative to the optical element holder, the shape-memory alloy wire includes a first wire provided between the support and the intermediate member, and a second wire provided between the intermediate member and the optical element holder, the first wire has one end supported by the support at a higher position than the other end supported by the intermediate member, the second wire has one end supported by the intermediate member at a higher position than the other end supported by the optical element holder, and the optical element holder moves in the predetermined direction by suppressing rotation about the predetermined axis by generating contraction of the first wire and contraction of the second wire upon applying a current to the first wire and the second wire.

### BRIEF DESCRIPTION OF THE DRAWINGS

FIG. 1 is a perspective view of a camera module including a lens drive device according to an embodiment of the present disclosure;

FIG. 2 is an exploded perspective view of the lens drive device;

FIG. 3 is a perspective view of a lens holder, lens-side metal members, a plate spring, flexible metal members, and lens-side embedded members;

FIG. 4 is a perspective view of the lens holder and the flexible metal members;

FIG. 5 is a perspective view of the intermediate member, an intermediate metal member, and an intermediate embedded member;

FIG. 6 is a perspective view of support-side metal members, the plate spring, the flexible metal members, a support, and support-side embedded members;

FIG. 7 is a perspective view of the lens drive device with a cover removed;

FIG. 8 is a diagram illustrating a configurational example of the metal members and shape-memory alloy wires;

FIG. 9 is a perspective view of the metal members, the flexible metal members, the lens-side embedded members, the intermediate embedded member, the support-side embedded members, and the shape-memory alloy wires;

FIG. 10 is perspective views of the metal members, the flexible metal members, the lens-side embedded members, the intermediate embedded member, the support-side embedded members, and the shape-memory alloy wires;

FIG. 11 is a top view and a front view of the lens holder, the intermediate member, and the support;

FIG. 12 is a top view and a front view of the lens holder, the intermediate member, and the support; and

FIG. 13 is a top view and a front view of the lens holder, the intermediate member, and the support.

### DETAILED DESCRIPTION OF THE PRESENT DISCLOSURE

As the number of pixels of an image sensor increases (image quality is enhanced), there is a possibility that the lens drive device may cause adverse effects on image quality due to rotation of a lens body around an optical-axis.

Therefore, it is desirable to provide an optical element drive device capable of suppressing rotation of an optical element such as the lens body around a predetermined axis such as the optical-axis.

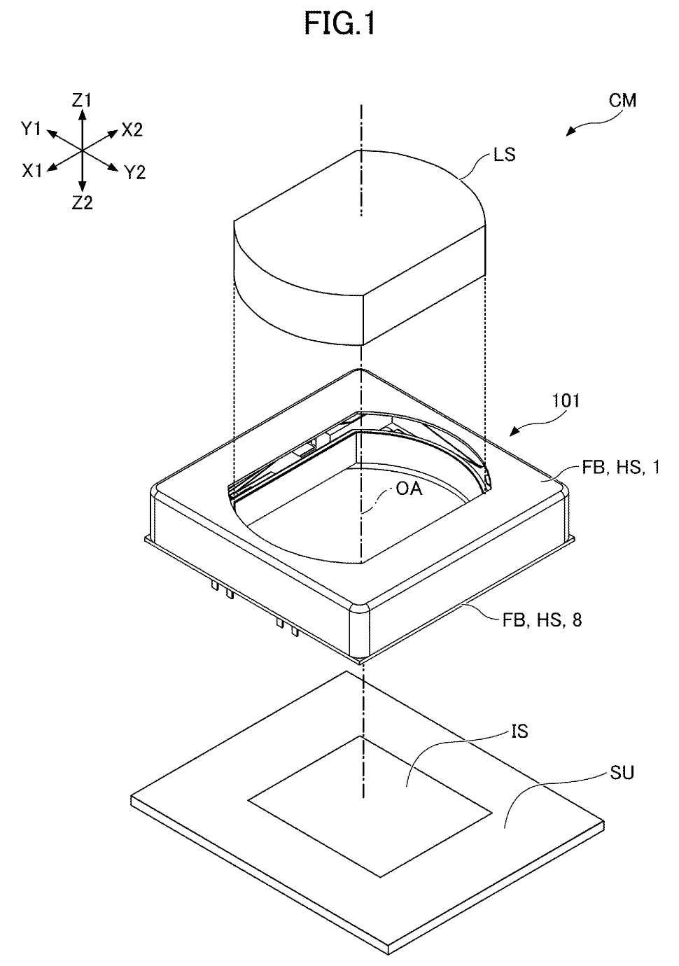

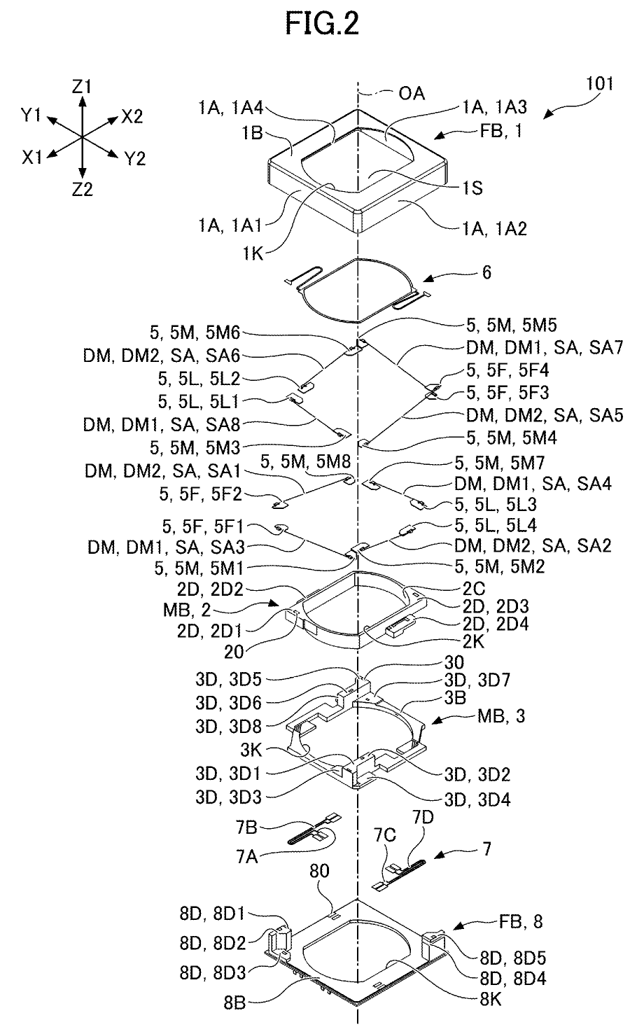

A lens drive device 101 according to an embodiment of the present disclosure will be described in the following with reference to the drawings. FIG. 1 is a perspective view of a camera module CM including the lens drive device 101. FIG. 2 is an exploded perspective view of the lens drive device 101.

In FIGS. 1 and 2, X1 represents one direction of an X-axis of a three-dimensional orthogonal coordinate system, and X2 represents the other direction of the X-axis. Y1 represents one direction of a Y-axis of the three-dimensional orthogonal coordinate system, and Y2 represents the other direction of the Y-axis. Similarly, Z1 represents one direction of a Z-axis of the three-dimensional orthogonal coordinate system, and Z2 represents the other direction of the Z-axis. In FIGS. 1 and 2, an X1 side of the lens drive device 101 corresponds to the front (front side) of the lens drive device 101, and an X2 side of the lens drive device 101 corresponds to the rear (rear side) of the lens drive device 101. A Y1 side of the lens drive device 101 corresponds to the left side of the lens drive device 101, and a Y2 side of the lens drive device 101 corresponds to the right side of the lens drive device 101. A Z1 side of the lens drive device 101 corresponds to an upper side (object side) of the lens drive device 101, and a Z2 side of the lens drive device 101 corresponds to a lower side (image sensor side) of the lens drive device 101. The same applies in other drawings.

As illustrated in FIG. 1, the camera module CM includes a substrate SU, the lens drive device 101, a lens body LS mounted on the lens drive device 101, and an image sensor IS mounted on the substrate SU to face the lens body LS. The camera module CM is connected to a controller (not illustrated) which includes a microcomputer including a CPU, a memory, and the like. In the illustrated example, the controller is disposed outside the camera module CM, but may be disposed inside the camera module CM. As illustrated in FIG. 1, the lens drive device 101 having a substantially rectangular parallelepiped shape is mounted on the substrate SU on which the imaging sensor IS is mounted.

Specifically, as illustrated in FIGS. 1 and 2, the lens drive device 101 includes a cover 1 and a support 8 that are part of a fixed-side member FB. The cover 1 is configured to function as a part of a housing HS of the lens drive device 101. In the illustrated example, the cover 1 includes a non-magnetic metal. However, the cover 1 may include a magnetic metal.

Specifically, as illustrated in FIG. 2, the cover 1 has an outer shape of a bottomless box defining a housing portion 1S. That is, the cover 1 has an outer-peripheral wall portion 1A having a rectangular-cylinder shape and a rectangular annular and flat top plate portion 1B provided to be continuous with an upper end (Z1-side end) of the outer-peripheral wall portion 1A. In the center of the top plate portion 1B, an opening 1K is formed in the shape of a substantially rounded rectangle. The outer-peripheral wall portion 1A includes a first side-plate portion 1A1 to a fourth side-plate portion 1A4. The first side-plate portion 1A1 and third side-plate portion 1A3 face each other, and the second side-plate portion 1A2 and fourth side-plate portion 1A4 face each other. The first side-plate portion 1A1 and third side-plate portion 1A3 extend perpendicularly to the second side-plate portion 1A2 and fourth side-plate portion 1A4. The cover 1 and the support 8 are joined together by an adhesive as illustrated in FIG. 1 to form the housing HS.

As illustrated in FIG. 2, a lens holder 2, an intermediate member 3, metal members 5, a plate spring 6, flexible metal members 7, lens-side embedded members 20, intermediate embedded members 30, support-side embedded members 80, shape-memory alloy wires SA, and the like are accommodated between the cover 1 and the support 8.

The lens holder 2 is a member capable of holding the lens body LS (see FIG. 1) and is included in a movable-side member MB. The lens body LS is, for example, a lens barrel including at least one lens, and is configured such that a center-axis of the lens barrel is along an optical-axis OA.

The lens holder 2 is a member movable in a Z-axis direction relative to the intermediate member 3 while rotating about the optical-axis OA, and is included in the movable-side member MB. In the illustrated example, the lens holder 2 is formed by injection molding a synthetic resin such as a liquid crystal polymer (LCP). Specifically, the lens holder 2 has a substantially rectangular outer shape in a plan view (top view) as viewed along an optical-axis direction, and includes a substantially rounded rectangular opening 2K in the center. Specifically, the lens holder 2 includes a cylindrical portion 2C having a rectangular annular shape formed to surround the opening 2K, and pedestal portions 2D formed to project from the cylindrical portion 2C toward the outside in a radial direction of a circle centered on the optical-axis OA. The pedestal portions 2D include a first pedestal portion 2D1 to a fourth pedestal portion 2D4. The first pedestal portion 2D1 and third pedestal portion 2D3 are arranged to extend in opposite directions in the radial direction (X-axis direction) across the optical-axis OA, and the second pedestal portion 2D2 and fourth pedestal portion 2D4 are arranged to extend in opposite directions in the radial direction (Y-axis direction) across the optical-axis OA. A part of the plate spring 6 is placed on the upper end surface of the cylindrical portion 2C. Lens-side metal members 5L are placed on the first pedestal portion 2D1 to fourth pedestal portion 2D4, respectively.

A driver DM is configured to move the movable-side member MB relative to the fixed-side member FB. In the illustrated example, the driver DM includes the shape-memory alloy wires SA which is an example of a shape-memory actuator. Specifically, the driver DM includes a first driver DM1 configured to move the lens holder 2 downward (Z2 side) and a second driver DM2 configured to move the lens holder 2 upward (Z1 side). The shape-memory alloy wires SA include a first wire SA1 to an eighth wire SA8. The first driver DM1 includes the third wire SA3, the fourth wire SA4, the seventh wire SA7, and the eighth wire SA8, and the second driver DM2 includes the first wire SA1, the second wire SA2, the fifth wire SA5, and the sixth wire SA6.

The shape-memory alloy wires SA are configured such that the temperature rises when a current flows and to contract in response to the temperature rise. Specifically, as illustrated in FIG. 2, each of the shape-memory alloy wires SA is configured such that it is stretched linearly along a corresponding inner surface of the outer-peripheral wall portion 1A of the cover 1 when a current is supplied, such that the lens holder 2 can be moved relative to the support 8. Each of the first wire SA1, the third wire SA3, the fifth wire SA5, and the seventh wire SA7 has one end fixed to a corresponding one of support-side metal members 5F by crimping, welding, etc., and the other end fixed to a corresponding one of intermediate metal members 5M by crimping, welding, etc. Each of the second wire SA2, the fourth wire SA4, the sixth wire SA6, and the eighth wire SA8 has one end fixed to a corresponding one of the intermediate metal members 5M by crimping, welding, etc., and the other end fixed to a corresponding one of the lens-side metal members 5L by crimping, welding, etc.

In the illustrated example, each of the first wire SA1, the second wire SA2, the fifth wire SA5, and the sixth wire SA6 are arranged to cross (substantially orthogonally) each of the third wire SA3, the fourth wire SA4, the seventh wire SA7, and the eighth wire SA8 when viewed along the optical-axis direction (Z-axis direction). The crossing of two shape-memory alloy wires means that a straight line passing through one end and the other end of one shape-memory alloy wire crosses a straight line passing through one end and the other end of the other shape-memory alloy wire. In other words, the first wire SA1, the second wire SA2, the fifth wire SA5, and the sixth wire SA6 are arranged to extend parallel to the X-axis direction, and the third wire SA3, the fourth wire SA4, the seventh wire SA7, and the eighth wire SA8 are arranged to extend parallel to the Y-axis direction.

The first driver DM1 can move the lens holder 2 downward (Z2 side) along the optical-axis direction (Z-axis direction) which is the direction parallel to the optical-axis OA by utilizing the contraction of the third wire SA3, the fourth wire SA4, the seventh wire SA7, and the eighth wire SA8. The third wire SA3, the fourth wire SA4, the seventh wire SA7, and the eighth wire SA8 are configured such that the lens holder 2 moves when one or more of the third wire SA3, the fourth wire SA4, the seventh wire SA7, and the eighth wire SA8 are contracted, and another one or more of the third wire SA3, the fourth wire SA4, the seventh wire SA7, and the eighth wire SA8 are stretched by the movement. Similarly, the second driver DM2 can move the lens holder 2 upward (Z1 side) along the optical-axis direction (Z-axis direction) by utilizing the contraction of the first wire SA1, the second wire SA2, the fifth wire SA5, and the sixth wire SA6. The first wire SA1, the second wire SA2, the fifth wire SA5, and the sixth wire SA6 are configured such that the lens holder 2 moves when one or more of the first wire SA1, the second wire SA2, the fifth wire SA5, and the sixth wire SA6 are contracted, and another one or more of the first wire SA1, the second wire SA2, the fifth wire SA5, and the sixth wire SA6 are stretched by the movement.

The intermediate member 3 is a member movable in the Z-axis direction relative to the fixed-side member FB (support 8) while rotating about the optical-axis OA, and is included in the movable-side member MB. In the illustrated example, the intermediate member 3 is formed by injection molding by using a synthetic resin such as a liquid crystal polymer (LCP). Specifically, the intermediate member 3 has a substantially rectangular outer shape in a plan view (top view) and has a substantially rounded rectangular opening 3K in the center. Specifically, the intermediate member 3 includes a rectangular annular base portion 3B formed to surround the opening 3K and pedestal portions 3D, each of which is a portion projecting upward from the base portion 3B. The pedestal portions 3D include a first pedestal portion 3D1 to eighth pedestal portion 3D8. The first pedestal portion 3D1 to fourth pedestal portion 3D4 and the fifth pedestal portion 3D5 to eighth pedestal portion 3D8 are arranged to face each other in the radial direction across the optical-axis OA. More specifically, the base portion 3B is provided with the first pedestal portion 3D1 to the fourth pedestal portion 3D4 at a right front corner and with the fifth pedestal portion 3D5 to the eighth pedestal portion 3D8 at a left rear corner. Each of the intermediate metal members 5M is placed on a corresponding pedestal portion from among the first pedestal portion 3D1 to the eighth pedestal portion 3D8.

Each metal member 5 is configured to fix thereto a part of the shape-memory alloy wire SA. In the illustrated example, the metal members 5 are formed of a non-magnetic metal and include the support-side metal members 5F, the lens-side metal members 5L, and the intermediate metal members 5M. The support-side metal members 5F are configured to be fixed to pedestal portions 8D of the support 8. The lens-side metal members 5L are configured to be fixed to the pedestal portions 2D of the lens holder 2. The intermediate metal members 5M are configured to be fixed to the pedestal portions 3D of the intermediate member 3. The support-side metal members 5F may be embedded in the pedestal portions 8D of the support 8, the lens-side metal members 5L may be embedded in the pedestal portions 2D of the lens holder 2, and the intermediate metal members 5M may be embedded in the pedestal portions 3D of the intermediate member 3.

More specifically, the support-side metal members 5F include a first support-side metal member 5F1 to a fourth support-side metal member 5F4, the lens-side metal members 5L include a first lens-side metal member 5L1 to a fourth lens-side metal member 5L4, and the intermediate metal members 5M include a first intermediate metal member 5M1 to an eighth intermediate metal member 5M8.

The plate spring 6 is configured to support the lens holder 2 movably in a direction parallel to the optical-axis OA with respect to the support 8. In the illustrated example, the plate spring 6 is made of a metal plate mainly made of, for example, a copper alloy, a titanium-copper alloy (titanium-copper), or a copper-nickel alloy (nickel-tin-copper). In the illustrated example, the plate spring 6 connects the lens holder 2 and the support 8 such that the center of the lens holder 2, the center of the intermediate member 3, and the center of the support 8 coincide with each other in a neutral state of the lens drive device 101. That is, the plate spring 6 is configured to center the lens holder 2 in an XY-plane with respect to the intermediate member 3 and the support 8. Specifically, the plate spring 6 is configured to connect the cylindrical portion 2C of the lens holder 2 and the pedestal portions 8D (specifically, a first pedestal portion 8D1 and a fourth pedestal portion 8D4) of the support 8. The neutral state of the lens drive device 101 is, for example, a state in which current is supplied to each of the first wire SA1 to the eighth wire SA8, and the movable-side member MB (the lens holder 2 and the intermediate member 3) is positioned in the middle of a movable range in the optical-axis direction, that is, the movable-side member MB (the lens holder 2 and the intermediate member 3) is in a neutral position. Typically, in the neutral state of the lens drive device 101, the lens holder 2 and the intermediate member 3 are positioned in the middle of the movable range in the optical-axis direction.

The flexible metal members 7 are members for supplying current to the shape-memory alloy wires SA. Specifically, each of the flexible metal members 7 includes a fixed joint to be fixed to the support 8, a movable joint to be fixed to the lens holder 2, and an elastically-deformable elastic arm configured to connect the fixed joint and the movable joint. In the illustrated example, each flexible metal member 7 includes a first flexible metal member 7A to a fourth flexible metal member 7D.

The support 8 is a member configured to support the movable-side member MB. In the illustrated example, the support 8 is formed by injection molding by using a synthetic resin such as a liquid crystal polymer (LCP), and is included in the fixed-side member FB. Specifically, the support 8 has a substantially rectangular outer shape in a plan view (top view) and includes a substantially rounded rectangular opening 8K in the center. The support 8 includes a rectangular annular base portion 8B formed to surround the opening 8K.

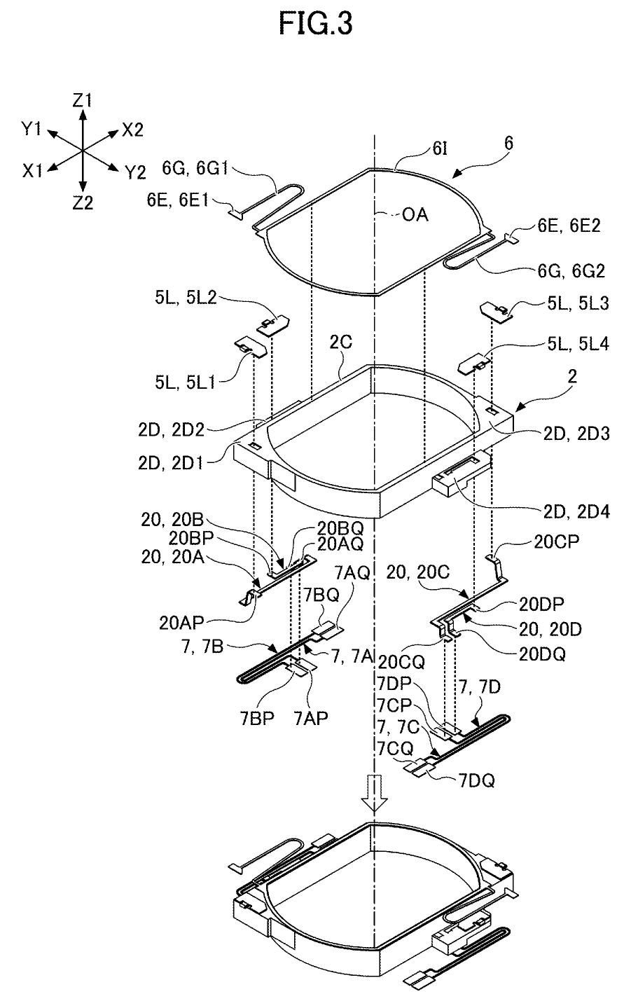

The lens-side embedded members 20 are metal members embedded in the lens holder 2. In the illustrated example, the lens-side embedded members 20 are members embedded in the lens holder 2 by insert molding and each of the lens-side embedded members 20 includes upper joints exposed on a surface of the lens holder 2 and lower joints, used for joining together with other metal members. Specifically, as illustrated in FIG. 3, the lens-side embedded members 20 include a first lens-side embedded member 20A to a fourth lens-side embedded member 20D.

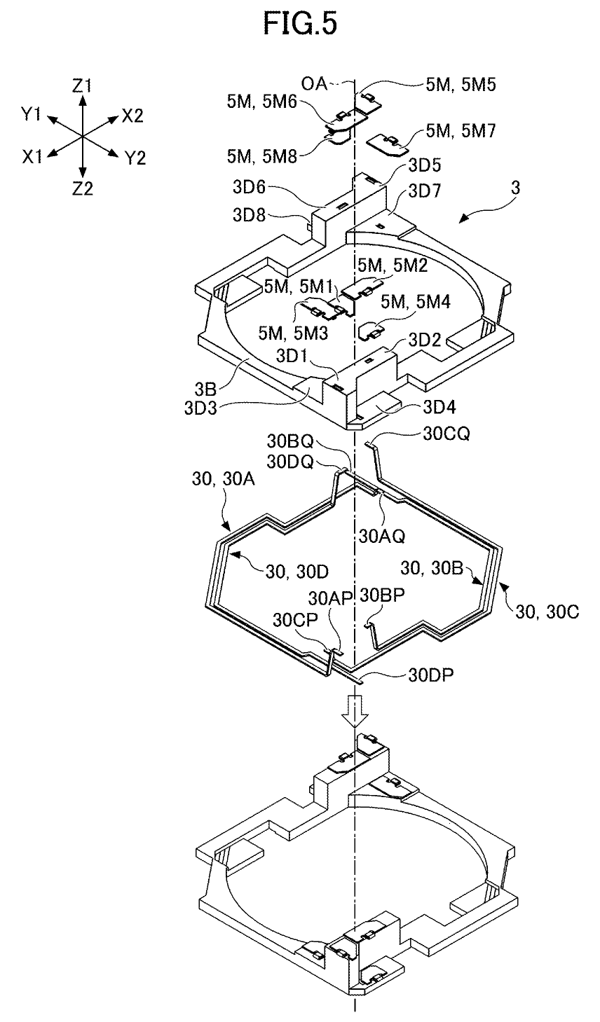

The intermediate embedded members 30 are metal members embedded in the intermediate member 3. In the illustrated example, the intermediate embedded members 30 are members embedded in the intermediate member 3 by insert molding and include front joints and rear joints exposed on the surface of the intermediate member 3 and used for joining together with other metal members. Specifically, the intermediate embedded members 30 include a first intermediate embedded member 30A to a fourth intermediate embedded member 30D as illustrated in FIG. 5.

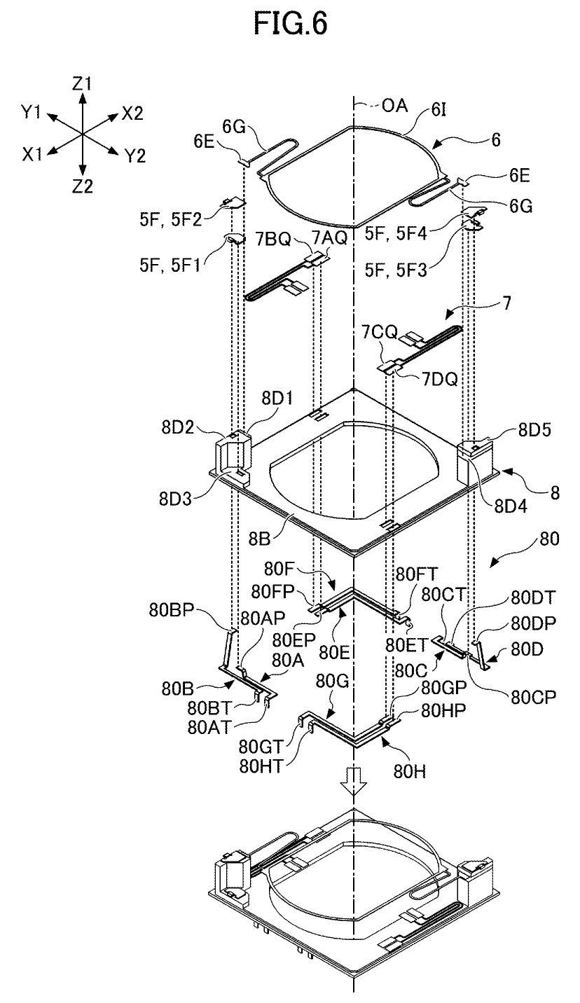

The support-side embedded members 80 are metal members embedded in the support 8. In the illustrated example, the support-side embedded members 80 are members embedded in the support 8 by insert molding and each of the support-side embedded members 80 includes a terminal used for electrical connection with the outside and a joint exposed on the surface of the support 8 and used for joining together with other metal members. Specifically, the support-side embedded members 80 include a first support-side embedded member 80A to an eighth support-side embedded member 80H as illustrated in FIG. 6.

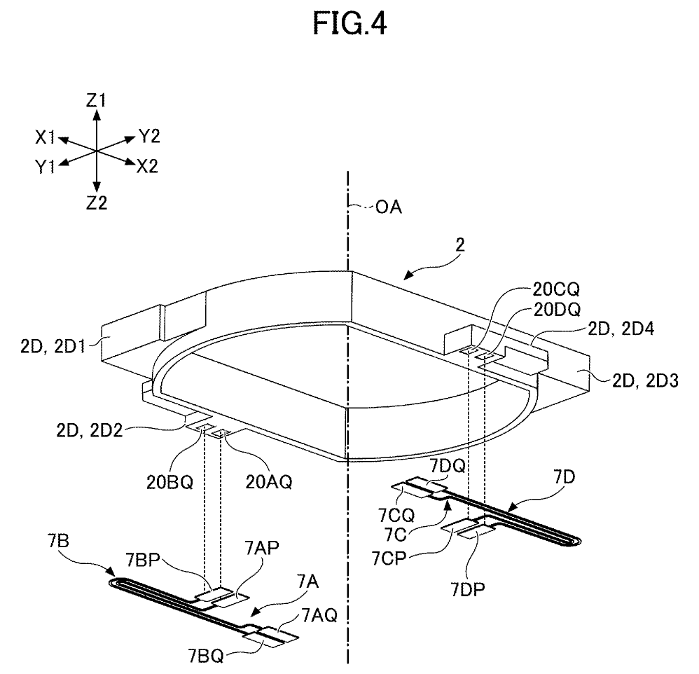

Next, with reference to FIGS. 3 and 4, the positional relationship between members attached to the lens holder 2 and the lens holder 2 will be described. FIG. 3 is a downward perspective view of the lens holder 2, the lens-side metal members 5L, the plate spring 6, the flexible metal members 7, and the lens-side embedded members 20. Specifically, the upper diagram of FIG. 3 (diagram above a block arrow) is an exploded perspective view, and the lower diagram of FIG. 3 (diagram below the block arrow) is an assembled perspective view. FIG. 4 is an upward perspective view of the lens holder 2 and the flexible metal members 7.

In the example as illustrated in the upper diagram of FIG. 3, the first lens-side metal member 5L1 is fixed to the upper surface of the first pedestal portion 2D1. Specifically, the first lens-side metal member 5L1 is fixed to the first pedestal portion 2D1 with an adhesive in a state of contact with a first upper joint 20AP of the first lens-side embedded member 20A exposed on the upper surface of the first pedestal portion 2D1. The adhesive is, for example, a photo-curable adhesive. The photo-curable adhesive is, for example, an ultraviolet-curable adhesive or a visible-light-curable adhesive. Similarly, the second lens-side metal member 5L2 is fixed to the second pedestal portion 2D2 by an adhesive in a state of contact with a second upper joint 20BP of the second lens-side embedded member 20B exposed on the upper surface of the second pedestal portion 2D2, the third lens-side metal member 5L3 is fixed to the third pedestal portion 2D3 by an adhesive in a state of contact with a third upper joint 20CP of the third lens-side embedded member 20C exposed on the upper surface of the third pedestal portion 2D3, and the fourth lens-side metal member 5L4 is fixed to the fourth pedestal portion 2D4 by an adhesive in a state of contact with a fourth upper joint 20DP of the fourth lens-side embedded member 20D exposed on the upper surface of the fourth pedestal portion 2D4. In the illustrated example, each of the lens-side metal members 5L is welded to the corresponding one of the lens-side embedded members 20.

The plate spring 6 includes outer portions 6E fixed to the pedestal portions 8D (see FIG. 2) of the support 8, an inner portion 6I to be fixed to the cylindrical portion 2C of the lens holder 2, and elastic portions 6G configured to connect the outer portions 6E and the inner portion 6I. Specifically, the outer portions 6E include a first outer portion 6E1 and a second outer portion 6E2, respectively, and the elastic portions 6G include a first elastic portion 6G1 and a second elastic portion 6G2, respectively. The first elastic portion 6G1 connects the inner portion 6I and the first outer portion 6E1, and the second elastic portion 6G2 connects the inner portion 6I and the second outer portion 6E2.

As illustrated in FIG. 3, the plate spring 6 is configured to be rotationally symmetric twice with respect to the optical-axis OA. Therefore, the plate spring 6 can support the lens holder 2 in the air with good balance. Moreover, the plate spring 6 does not adversely affect the weight balance of the movable-side member MB (the lens holder 2 and the intermediate member 3) supported by the eight shape-memory alloy wires SA (the first wire SA1 to the eighth wire SA8).

The first lens-side embedded member 20A includes the first upper joint 20AP exposed on the upper surface of the first pedestal portion 2D1 and a first lower joint 20AQ exposed on the lower surface of the second pedestal portion 2D2, and the second lens-side embedded member 20B includes a second upper joint 20BP exposed on the upper surface of the second pedestal portion 2D2 and a second lower joint 20BQ exposed on the lower surface of the second pedestal portion 2D2. The first upper joint 20AP and the first lens-side metal member 5L1 are joined together by welding, the second upper joint 20BP and the second lens-side metal member 5L2 are joined together by welding, the first lower joint 20AQ and a first movable joint 7AP of the first flexible metal member 7A are joined together by welding, and the second lower joint 20BQ and a second movable joint 7BP of the second flexible metal member 7B are joined together by welding. Similarly, the third lens-side embedded member 20C includes a third upper joint 20CP exposed on the upper surface of the third pedestal portion 2D3 and a third lower joint 20CQ exposed on the lower surface of the fourth pedestal portion 2D4, and the fourth lens-side embedded member 20D includes a fourth upper joint 20DP exposed on the upper surface of the fourth pedestal portion 2D4 and a fourth lower joint 20DQ exposed on the lower surface of the fourth pedestal portion 2D4. The third upper joint 20CP and the third lens-side metal member 5L3 are joined together by welding, the fourth upper joint 20DP and the fourth lens-side metal member 5L4 are joined together by welding, the third lower joint 20CQ and a third movable joint 7CP of the third flexible metal member 7C are joined together by welding, and the fourth lower joint 20DQ and a fourth movable joint 7DP of the fourth flexible metal member 7D are joined together by welding. The joining together of components by welding may be replaced by bonding by using a conductive adhesive or soldering.

Next, with reference to FIG. 5, the positional relationship between members contacting the intermediate member 3 and the intermediate member 3 will be described. FIG. 5 is a downward perspective view of the intermediate member 3, intermediate metal members 5M, and the intermediate embedded members 30. Specifically, the upper diagram of FIG. 5 (diagram above the block arrow) is an exploded perspective view, and the lower diagram of FIG. 5 (diagram below the block arrow) is an assembled perspective view.

In the example as illustrated in the upper diagram of FIG. 5, the first intermediate metal member 5M1 is fixed to the upper surface of the first pedestal portion 3D1 of the intermediate member 3, the second intermediate metal member 5M2 is fixed to the upper surface of the second pedestal portion 3D2 of the intermediate member 3, the third intermediate metal member 5M3 is fixed to the upper surface of the third pedestal portion 3D3 of the intermediate member 3, and the fourth intermediate metal member 5M4 is fixed to the upper surface of the fourth pedestal portion 3D4 of the intermediate member 3. Similarly, the fifth intermediate metal member 5M5 is fixed to the upper surface of the fifth pedestal portion 3D5 of the intermediate member 3, the sixth intermediate metal member 5M6 is fixed to the upper surface of the sixth pedestal portion 3D6 of the intermediate member 3, the seventh intermediate metal member 5M7 is fixed to the upper surface of the seventh pedestal portion 3D7 of the intermediate member 3, and the eighth intermediate metal member 5M8 is fixed to the upper surface of the eighth pedestal portion 3D8 of the intermediate member 3. In the illustrated example, the upper surfaces of the eight pedestal portions 3D are perpendicular to the optical-axis OA. The upper surfaces of the first pedestal portion 3D1, the second pedestal portion 3D2, the fifth pedestal portion 3D5, and the sixth pedestal portion 3D6 are at the same height, the upper surfaces of the third pedestal portion 3D3 and the seventh pedestal portion 3D7 are at the same height, and the upper surfaces of the fourth pedestal portion 3D4 and the eighth pedestal portion 3D8 are at the same height.

The first intermediate embedded member 30A includes a first front joint 30AP exposed on the upper surface of the first pedestal portion 3D1 of the intermediate member 3 and a first rear joint 30AQ exposed on the upper surface of the seventh pedestal portion 3D7 of the intermediate member 3. The second intermediate embedded member 30B includes a second front joint 30BP exposed on the upper surface of the second pedestal portion 3D2 of the intermediate member 3 and a second rear joint 30BQ exposed on the upper surface of the eighth pedestal portion 3D8 of the intermediate member 3. The third intermediate embedded member 30C includes a third front joint 30CP exposed on the upper surface of the third pedestal portion 3D3 of the intermediate member 3 and a third rear joint 30CQ exposed on the upper surface of the fifth pedestal portion 3D5 of the intermediate member 3. The fourth intermediate embedded member 30D includes a fourth front joint 30DP exposed on the upper surface of the fourth pedestal portion 3D4 of the intermediate member 3 and a fourth rear joint 30DQ exposed on the upper surface of the sixth pedestal portion 3D6 of the intermediate member 3.

The first front joint 30AP and the first intermediate metal member 5M1 are joined together by welding. The first front joint 30AP and the first intermediate metal member 5M1 may be joined together by using a conductive adhesive, soldering, or the like. The same applies to the joining of the second front joint 30BP to the second intermediate metal member 5M2, the joining of the third front joint 30CP to the third intermediate metal member 5M3, the joining of the fourth front joint 30DP to the fourth intermediate metal member 5M4, the joining of the third rear joint 30CQ to the fifth intermediate metal member 5M5, the joining of the fourth rear joint 30DQ to the sixth intermediate metal member 5M6, the joining of the first rear joint 30AQ to the seventh intermediate metal member 5M7, and the joining of the second rear joint 30BQ to the eighth intermediate metal member 5M8.

Next, with reference to FIG. 6, the positional relationship between members attached to the support 8 and the support 8 will be described. FIG. 6 is a downward perspective view of the support-side metal members 5F, the plate spring 6, the flexible metal members 7, the support 8, and the support-side embedded member 80. Specifically, the upper diagram of FIG. 6 (diagram above the block arrow) is an exploded perspective view, and the lower diagram of FIG. 6 (diagram below the block arrow) is an assembled perspective view.

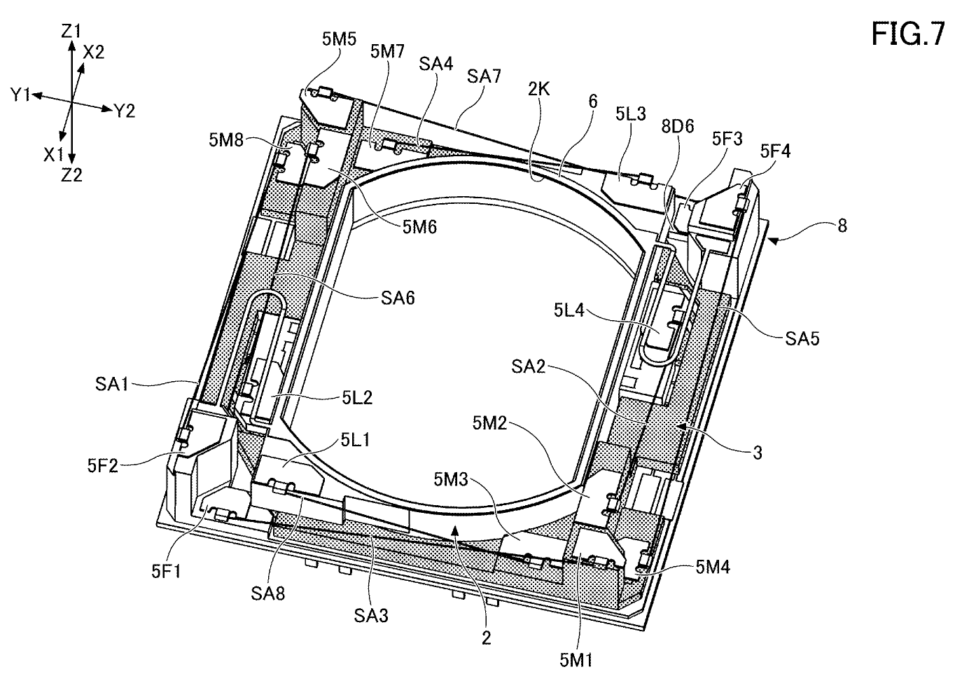

In the example as illustrated in the upper diagram of FIG. 6, the first support-side metal member 5F1 is fixed to the upper surface of a third pedestal portion 8D3 of the support 8, the second support-side metal member 5F2 is fixed to the upper surface of a second pedestal portion 8D2 of the support 8, the third support-side metal member 5F3 is fixed to the upper surface of a sixth pedestal portion 8D6 (see FIG. 7) of the support 8, and the fourth support-side metal member 5F4 is fixed to the upper surface of a fifth pedestal portion 8D5 of the support 8. In the illustrated example, the upper surfaces of the six pedestal portions 8D are perpendicular to the optical-axis OA. The upper surfaces of the first pedestal portion 8D1 and the fourth pedestal portion 8D4 are at the same height, the upper surfaces of the second pedestal portion 8D2 and the fifth pedestal portion 8D5 are at the same height, and the upper surfaces of the third pedestal portion 8D3 and the sixth pedestal portion 8D6 are at the same height.

As illustrated in FIG. 6, the first flexible metal member 7A to the fourth flexible metal member 7D include a first fixed joint 7AQ to a fourth fixed joint 7DQ, respectively. The first support-side embedded member 80A to the eighth support-side embedded member 80H include a first terminal 80AT to an eighth terminal 80HT and a first joint 80AP to an eighth joint 80HP, respectively. The first joint 80AP to the eighth joint 80HP are exposed on the upper surface of the support 8.

Specifically, the first support-side embedded member 80A includes the first joint 80AP exposed on the upper surface of the third pedestal portion 8D3 of the support 8 and a first terminal 80AT exposed on the front surface of the support 8. The second support-side embedded member 80B includes a second joint 80BP exposed on the upper surface of the second pedestal portion 8D2 of the support 8 and the second terminal 80BT exposed on the front surface of the support 8. The third support-side embedded member 80C includes the third joint 80CP exposed on the upper surface of the sixth pedestal portion 8D6 of the support 8 and the third terminal 80CT exposed on the rear surface of the support 8. The fourth support-side embedded member 80D includes the fourth joint 80DP exposed on the upper surface of the fifth pedestal portion 8D5 of the support 8 and the fourth terminal 80DT exposed on the rear surface of the support 8. The fifth support-side embedded member 80E includes the fifth joint 80EP exposed on the upper surface of a left-side portion of the base portion 8B of the support 8 and a fifth terminal 80ET exposed on the rear surface of the support 8. The sixth support-side embedded member 80F includes the sixth joint 80FP exposed on the upper surface of the left-side portion of the base portion 8B of the support 8 and the sixth terminal 80FT exposed on the rear surface of the support 8. The seventh support-side embedded member 80G includes the seventh joint 80GP exposed on the upper surface of a right-side portion of the base portion 8B of the support 8 and the seventh terminal 80GT exposed on the front surface of the support 8. The eighth support-side embedded member 80H includes the eighth joint 80HP exposed on the upper surface of the right-side portion of the base portion 8B of the support 8 and the eighth terminal 80HT exposed on the front side surface of the support 8.

The first joint 80AP and the first support-side metal member 5F1 are joined together by welding. The first joint 80AP and the first support-side metal member 5F1 may be joined together by using a conductive adhesive or by soldering. The same applies to the joining of the second joint 80BP to the second support-side metal member 5F2, the joining of the third joint 80CP to the third support-side metal member 5F3, the joining of the fourth joint 80DP to the fourth support-side metal member 5F4, the joining of the fifth joint 80EP to the first fixed joint 7AQ, the joining of the sixth joint 80FP to a second fixed joint 7BQ, the joining of the seventh joint 80GP to the third fixed joint 7CQ, and the joining of the eighth joint 80HP to the fourth fixed joint 7DQ.

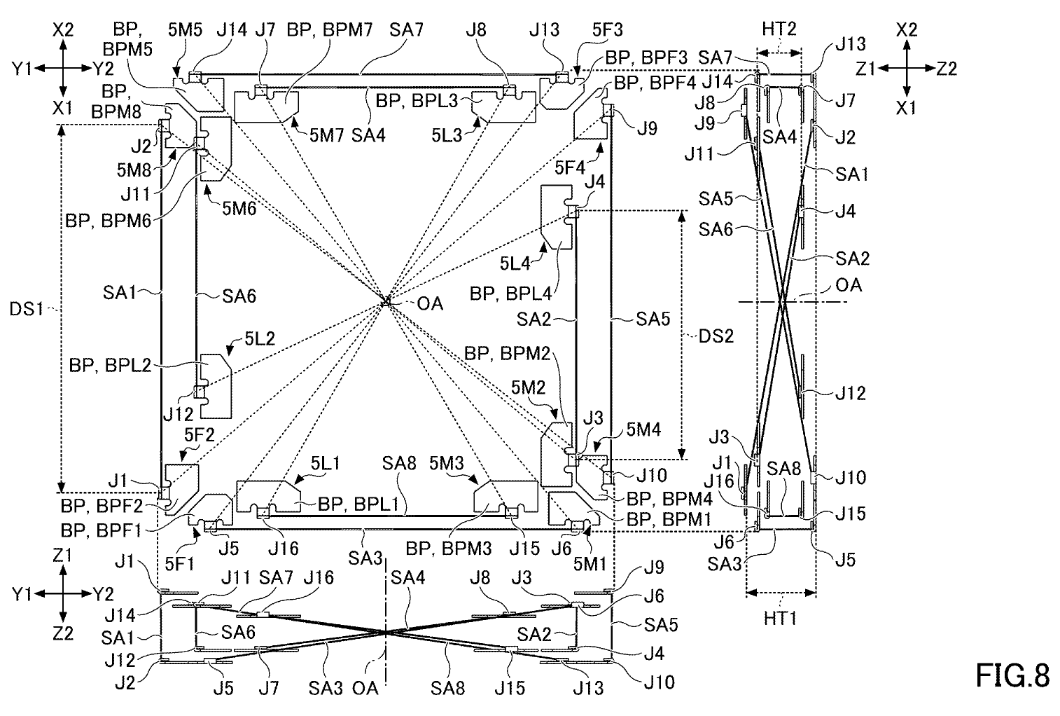

Next, the metal members 5 to which the shape-memory alloy wires SA are attached will be described with reference to FIGS. 7 and 8. FIG. 7 is a perspective view of the lens drive device 101 with the cover 1 removed. In FIG. 7, a dot pattern is applied to the intermediate member 3 for clarity. FIG. 8 is a diagram illustrating a configurational example of the metal members 5 (the support-side metal members 5F, the lens-side metal members 5L, and the intermediate metal members 5M) and the shape-memory alloy wires SA. Specifically, the upper left diagram of FIG. 8 is a top view of the metal members 5 (the support-side metal members 5F, the lens-side metal members 5L, and the intermediate metal members 5M) and the shape-memory alloy wires SA. The lower left diagram of FIG. 8 is a front view of the metal members 5 (support-side metal members 5F, lens-side metal members 5L, and intermediate metal members 5M) and the shape-memory alloy wires SA. The right diagram of FIG. 8 is a right side view of the metal members 5 (the support-side metal members 5F, the lens-side metal members 5L, and the intermediate metal members 5M) and the shape-memory alloy wires SA. The positional relationship of each member as illustrated in FIG. 8 corresponds to the positional relationship when the lens drive device 101 is in a neutral state.

Specifically, one end of the first wire SA1 is fixed to the second support-side metal member 5F2 at a holding portion J1 of the second support-side metal member 5F2, and the other end of the first wire SA1 is fixed to the eighth intermediate metal member 5M8 at a holding portion J2 of the eighth intermediate metal member 5M8. One end of the second wire SA2 is fixed to the second intermediate metal member 5M2 at a holding portion J3 of the second intermediate metal member 5M2, and the other end of the second wire SA2 is fixed to the fourth lens-side metal member 5L4 at a holding portion J4 of the fourth lens-side metal member 5L4. One end of the third wire SA3 is fixed to the first support-side metal member 5F1 at a holding portion J5 of the first support-side metal member 5F1, and the other end of the third wire SA3 is fixed to the first intermediate metal member 5M1 at a holding portion J6 of the first intermediate metal member 5M1. One end of the fourth wire SA4 is fixed to the seventh intermediate metal member 5M7 at a holding portion J7 of the seventh intermediate metal member 5M7, and the other end of the fourth wire SA4 is fixed to the third lens-side metal member 5L3 at a holding portion J8 of the third lens-side metal member 5L3.

Similarly, one end of the fifth wire SA5 is fixed to the fourth support-side metal member 5F4 at a holding portion J9 of the fourth support-side metal member 5F4, and the other end of the fifth wire SA5 is fixed to the fourth intermediate metal member 5M4 at a holding portion J10 of the fourth intermediate metal member 5M4. One end of the sixth wire SA6 is fixed to the sixth intermediate metal member 5M6 at a holding portion J11 of the sixth intermediate metal member 5M6, and the other end of the sixth wire SA6 is fixed to the second lens-side metal member 5L2 at a holding portion J12 of the second lens-side metal member 5L2. One end of the seventh wire SA7 is fixed to the third support-side metal member 5F3 at a holding portion J13 of the third support-side metal member 5F3, and the other end of the seventh wire SA7 is fixed to the fifth intermediate metal member 5M5 at a holding portion J14 of the fifth intermediate metal member 5M5. One end of the eighth wire SA8 is fixed to the third intermediate metal member 5M3 at a holding portion J15 of the third intermediate metal member 5M3, and the other end of the eighth wire SA8 is fixed to the first lens-side metal member 5L1 at a holding portion J16 of the first lens-side metal member 5L1.

The holding portion J1 is formed by bending a part of the second support-side metal member 5F2. Specifically, a part of the second support-side metal member 5F2 is bent while holding one end of the first wire SA1 to form the holding portion J1. One end of the first wire SA1 is fixed to the holding portion J1 by welding. The same applies to the holding portions J2 to J16.

Also, as illustrated in the right diagram of FIG. 8, the first wire SA1 and the second wire SA2 are arranged to be diagonally downward to the right in the right side view, and the fifth wire SA5 and the sixth wire SA6 are arranged to be diagonally upward to the right in the right side view. Then, the first wire SA1 and the second wire SA2 are arranged to cross the fifth wire SA5 and the sixth wire SA6 in the right side view. Similarly, the third wire SA3 and the fourth wire SA4 are arranged to be diagonally upward to the right in the front view, and the seventh wire SA7 and the eighth wire SA8 are arranged to be diagonally downward to the right in the front view. The third wire SA3 and the fourth wire SA4 are arranged to cross the seventh wire SA7 and the eighth wire SA8 in the front view.

The support 8 is configured to support one end in each of the first wire SA1, the third wire SA3, the fifth wire SA5, and the seventh wire SA7, and the intermediate member 3 is configured to support the other end in each of the first wire SA1, the third wire SA3, the fifth wire SA5, and the seventh wire SA7. With this structure, the intermediate member 3 is connected to the support 8 in a state movable in the optical-axis direction (Z-axis direction), which is a direction parallel to the optical-axis OA, via the first wire SA1, the third wire SA3, the fifth wire SA5, and the seventh wire SA7.

The intermediate member 3 is configured to support one end in each of the second wire SA2, the fourth wire SA4, the sixth wire SA6, and the eighth wire SA8, and the lens holder 2 is configured to support the other end in each of the second wire SA2, the fourth wire SA4, the sixth wire SA6, and the eighth wire SA8. With this structure, the lens holder 2 is connected to the intermediate member 3 via the second wire SA2, the fourth wire SA4, the sixth wire SA6, and the eighth wire SA8 in a state movable in the optical-axis direction (Z-axis direction), which is the direction parallel to the optical-axis OA.

In the illustrated example, each of the support-side metal members 5F, lens-side metal members 5L, and intermediate metal members 5M is formed of a metal plate including a plate-like base portion BP. Specifically, the first support-side metal member 5F1 includes a base portion BPF1, the second support-side metal member 5F2 includes a base portion BPF2, the third support-side metal member 5F3 includes a base portion BPF3, the fourth support-side metal member 5F4 includes a base portion BPF4, the first lens-side metal member 5L1 includes a base portion BPL1, the second lens-side metal member 5L2 includes a base portion BPL2, the third lens-side metal member 5L3 includes a base portion BPL3, the fourth lens-side metal member 5L4 includes a base portion BPL4, the first intermediate metal member 5M1 includes a base portion BPM1, the second intermediate metal member 5M2 includes a base portion BPM2, and the third intermediate metal member 5M3 includes a base portion BPM3. The fourth intermediate metal member 5M4 includes a base portion BPM4, the fifth intermediate metal member 5M5 includes a base portion BPM5, the sixth intermediate metal member 5M6 includes a base portion BPM6, the seventh intermediate metal member 5M7 includes a base portion BPM7, and the eighth intermediate metal member 5M8 includes a base portion BPM8.

As illustrated in the right diagram of FIG. 8, the 16 metal members 5 (first support-side metal member 5F1 to fourth support-side metal member 5F4, first lens-side metal member 5L1 to fourth lens-side metal member 5L4, and first intermediate metal member 5M1 to eighth intermediate metal member 5M8) are attached to the lens holder 2, the intermediate member 3, or the support 8 such that all plate surfaces of the base portions BP are parallel to the XY-plane, that is, substantially parallel to each other.

As illustrated in FIG. 7, with respect to the first wire SA1, the second support-side metal member 5F2 is arranged at a position higher than the eighth intermediate metal member 5M8 in the Z-axis direction; with respect to the second wire SA2, the second intermediate metal member 5M2 is arranged at a position higher than the fourth lens-side metal member 5L4 in the Z-axis direction; with respect to the third wire SA3, the first intermediate metal member 5M1 is arranged at a position higher than the first support-side metal member 5F1 in the Z-axis direction; and with respect to the fourth wire SA4, the third lens-side metal member 5L3 is arranged at a position higher than the seventh intermediate metal member 5M7 in the Z-axis direction. Similarly, with respect to the fifth wire SA5, the fourth support-side metal member 5F4 is arranged at a position higher than the fourth intermediate metal member 5M4 in the Z-axis direction; with respect to the sixth wire SA6, the sixth intermediate metal member 5M6 is arranged at a position higher than the second lens-side metal member 5L2 in the Z-axis direction, with respect to the seventh wire SA7, the fifth intermediate metal member 5M5 is arranged at a position higher than the third support-side metal member 5F3 in the Z-axis direction; and with respect to the eighth wire SA8, the first lens-side metal member 5L1 is arranged at a position higher than the third intermediate metal member 5M3 in the Z-axis direction.

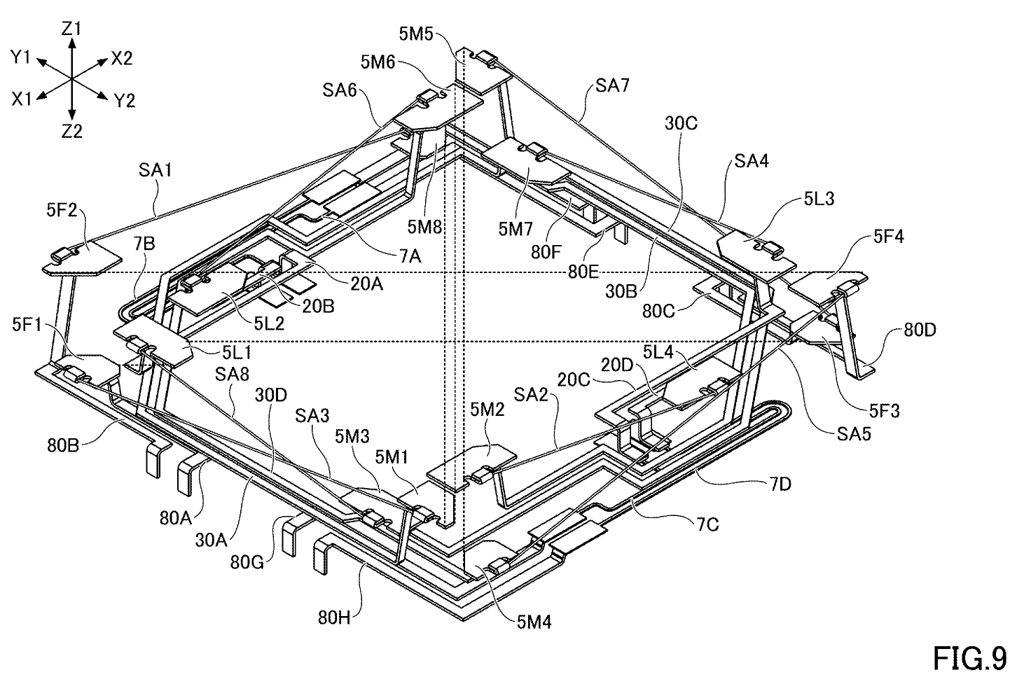

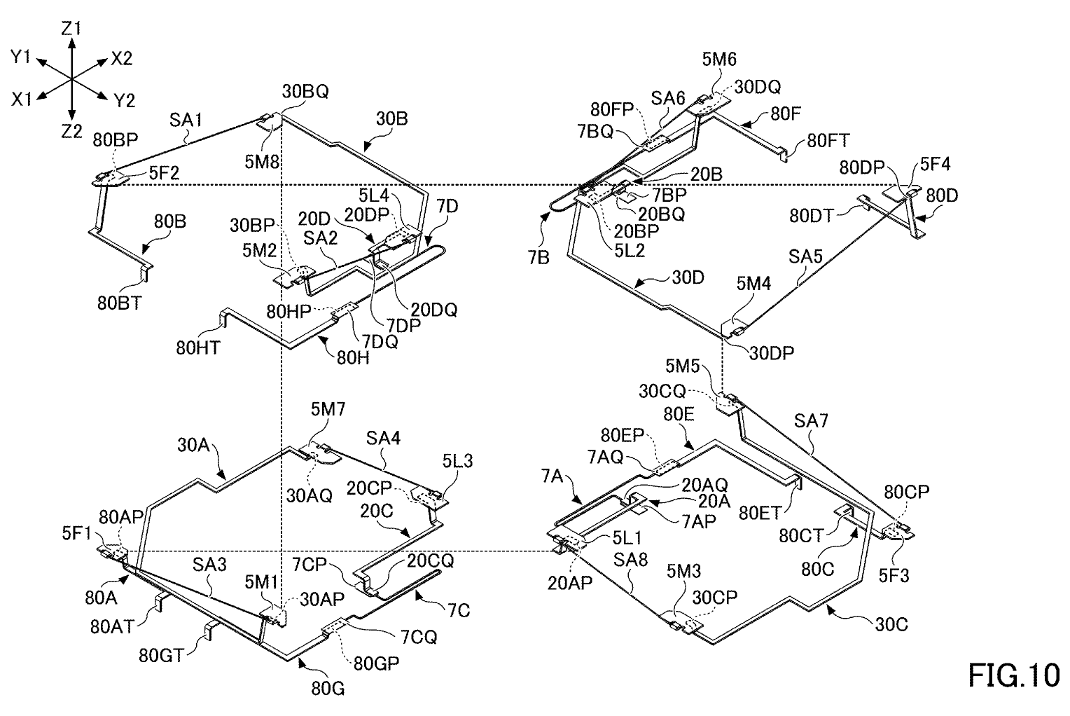

Next, with reference to FIGS. 9 and 10, the positional relationship between the metal members 5 (the support-side metal members 5F, the lens-side metal members 5L, and the intermediate metal members 5M), the flexible metal members 7, the lens-side embedded members 20, the intermediate embedded members 30, the support-side embedded members 80, and the shape-memory alloy wires SA, which are members through which a current flows, will be described. FIG. 9 is a perspective view of the metal members 5 (the support-side metal members 5F, the lens-side metal members 5L, and the intermediate metal members 5M), the flexible metal members 7, the lens-side embedded members 20, the intermediate embedded members 30, the support-side embedded members 80, and the shape-memory alloy wires SA. FIG. 10 is partially extracted views of FIG. 9, wherein the upper left diagram of FIG. 10 illustrates members associated with an energizing path including the first wire SA1 and the second wire SA2; the lower left diagram of FIG. 10 illustrates members associated with an energizing path including the third wire SA3 and the fourth wire SA4; the upper right diagram of FIG. 10 illustrates members associated with an energizing path including the fifth wire SA5 and the sixth wire SA6; and the lower right diagram of FIG. 10 illustrates members associated with an energizing path including the seventh wire SA7 and the eighth wire SA8.

As illustrated in the upper left diagram of FIG. 10, when the second terminal 80BT of the second support-side embedded member 80B is connected to a high potential and the eighth terminal 80HT of the eighth support-side embedded member 80H is connected to a low potential, the current flows from the second terminal 80BT of the second support-side embedded member 80B to the second joint 80BP of the second support-side embedded member 80B, the second support-side metal member 5F2, the first wire SA1, the eighth intermediate metal member 5M8, the second intermediate embedded member 30B (the second rear joint 30BQ and the second front joint 30BP), the second intermediate metal member 5M2, the second wire SA2, the fourth lens-side metal member 5L4, the fourth lens-side embedded member 20D (the fourth upper joint 20DP and the fourth lower joint 20DQ), the fourth flexible metal member 7D (the fourth movable joint 7DP and the fourth fixed joint 7DQ), and the eighth joint 80HP of the eighth support-side embedded member 80H to the eighth terminal 80HT of the eighth support-side embedded member 80H.

Furthermore, as illustrated in the lower left diagram of FIG. 10, when the first terminal 80AT of the first support-side embedded member 80A is connected to a high potential and the seventh terminal 80GT of the seventh support-side embedded member 80G is connected to a low potential, the current flows from the first terminal 80AT of the first support-side embedded member 80A to the first joint 80AP of the first support-side embedded member 80A, the first support-side metal member 5F1, the third wire SA3, the first intermediate metal member 5M1, the first intermediate embedded member 30A (the first front joint 30AP and the first rear joint 30AQ), the seventh intermediate metal member 5M7, the fourth wire SA4, the third lens-side metal member 5L3, the third lens-side embedded member 20C (the third upper joint 20CP and the third lower joint 20CQ), the third flexible metal member 7C (the third movable joint 7CP and the third fixed joint 7CQ), and the seventh joint 80GP of the seventh support-side embedded member 80G to the seventh terminal 80GT of the seventh support-side embedded member 80G.

Furthermore, as illustrated in the upper right diagram of FIG. 10, when the fourth terminal 80DT of the fourth support-side embedded member 80D is connected to a high potential and the sixth terminal 80FT of the sixth support-side embedded member 80F is connected to a low potential, the current flows from the fourth terminal 80DT of the fourth support-side embedded member 80D to the fourth joint 80DP of the fourth support-side embedded member 80D, the fourth support-side metal member 5F4, the fifth wire SA5, the fourth intermediate metal member 5M4, the fourth intermediate embedded member 30D (the fourth front joint 30DP and the fourth rear joint 30DQ), the sixth intermediate metal member 5M6, the sixth wire SA6, the second lens-side metal member 5L2, the second lens-side embedded member 20B (the second upper joint 20BP and second lower joint 20BQ), the second flexible metal member 7B (the second movable joint 7BP and the second fixed joint 7BQ), and the sixth joint 80FP of the sixth support-side embedded member 80F to the sixth terminal 80FT of the sixth support-side embedded member 80F.

When the third terminal 80CT of the third support-side embedded member 80C is connected to a high potential and the fifth terminal 80ET of the fifth support-side embedded member 80E is connected to a low potential, as illustrated in the lower right diagram of FIG. 10, the current flows from the third terminal 80CT of the third support-side embedded member 80C to the third joint 80CP of the third support-side embedded member 80C, the third support-side metal member 5F3, the seventh wire SA7, the fifth intermediate metal member 5M5, the third intermediate embedded member 30C (the third rear joint 30CQ and the third front joint 30CP), the third intermediate metal member 5M3, the eighth wire SA8, the first lens-side metal member 5L1, the first lens-side embedded member 20A (the first upper joint 20AP and the first lower joint 20AQ), the first flexible metal member 7A (the first movable joint 7AP and the first fixed joint 7AQ), and the fifth joint 80EP of the fifth support-side embedded member 80E to the fifth terminal 80ET of the fifth support-side embedded member 80E.

The controller located outside the lens drive device 101 as described above can control the respective lengths of the shape-memory alloy wires SA (the first wire SA1 to the eighth wire SA8) by controlling the voltages applied to the respective terminals (the first terminal 80AT to the eighth terminal 80HT) of the first support-side embedded member 80A to the eighth support-side embedded member 80H. For example, the controller may detect respective electrical resistance values of the shape-memory alloy wires SA and control the respective lengths of the shape-memory alloy wires SA according to detection results. The controller may be disposed in the lens drive device 101. The controller may be a component of the lens drive device 101.

The controller may, for example, move the lens holder 2 along the direction parallel to the optical-axis OA (Z-axis direction) on the Z1 side (subject side) of the imaging sensor IS by using the driving force along the direction parallel to the optical-axis OA caused by the contraction of the shape-memory alloy wires SA as the driver DM. By moving the lens holder 2 in this way, the controller may achieve an automatic focus adjustment function, which is one of lens adjustment functions. Specifically, the controller may move the lens holder 2 in the direction so as to be away from the image sensor to enable macro imaging, and may move the lens holder 2 in the direction toward the image sensor to enable infinity imaging.

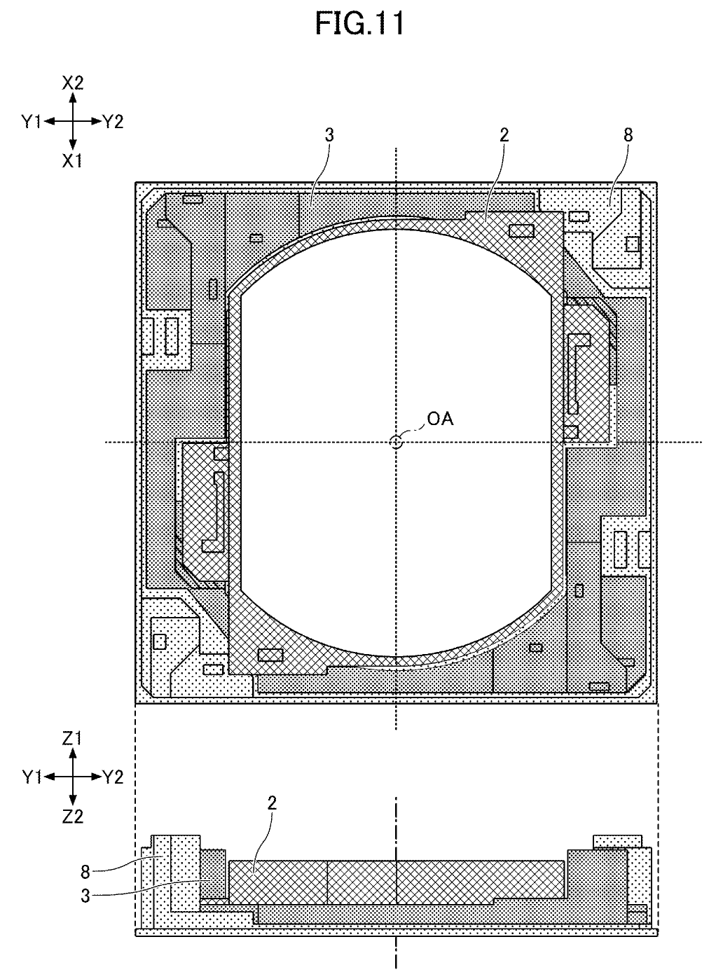

Next, referring to FIGS. 11 to 13, the movement of the movable-side member MB relative to the fixed-side member FB will be described. FIGS. 11 to 13 are schematic views of the lens holder 2, the intermediate member 3, and the support 8. Specifically, the upper diagrams in FIGS. 11 to 13 are top views including the lens holder 2, the intermediate member 3, and the support 8, and the lower diagrams in FIGS. 11 to 13 are front views including the lens holder 2, the intermediate member 3, and the support 8. In FIGS. 11 to 13, a cross pattern is applied to the lens holder 2, a fine dot pattern is applied to the intermediate member 3, and a coarse dot pattern is applied to the support 8 for clarity.

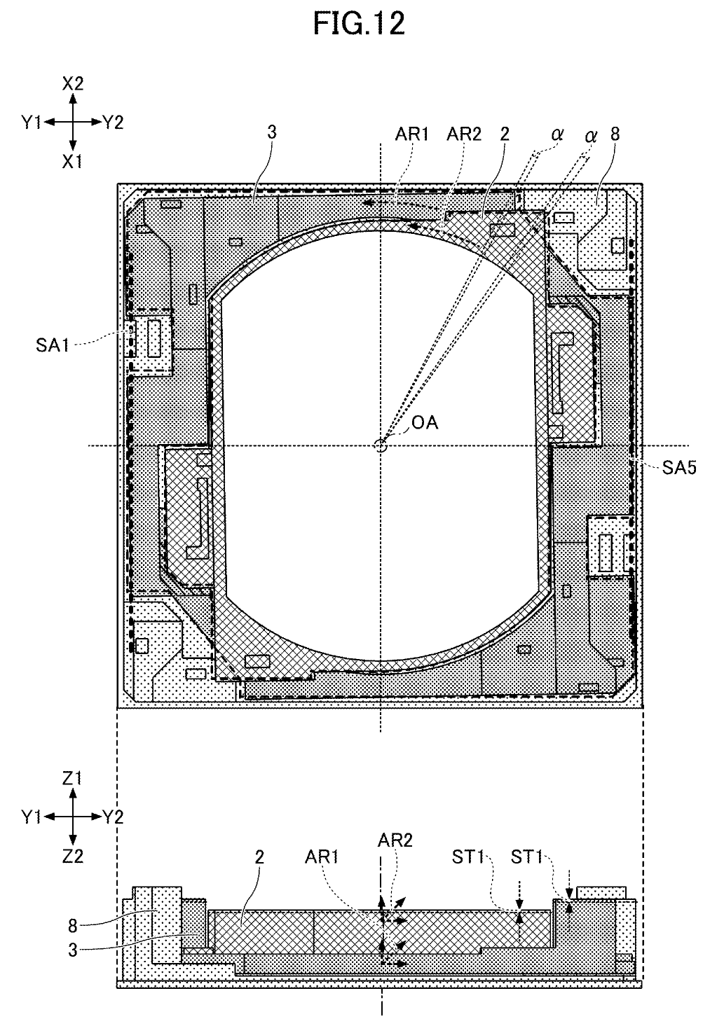

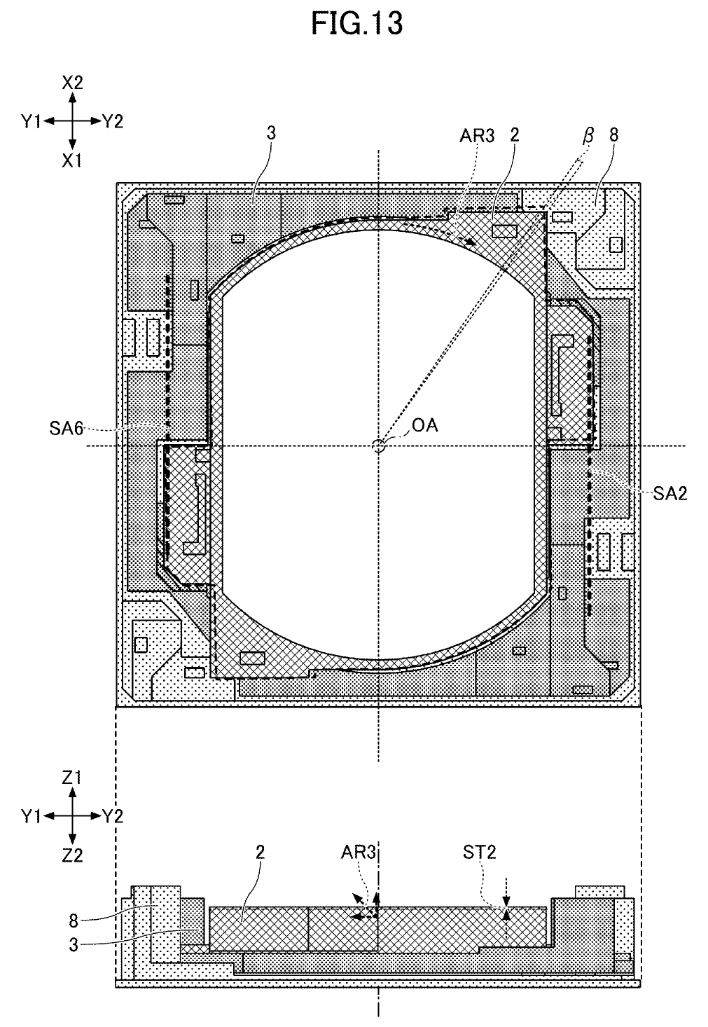

More specifically, FIG. 11 illustrates the positional relationship of the lens holder 2, the intermediate member 3, and the support 8 when the lens drive device 101 is in the neutral state. FIG. 12 illustrates the positional relationship of the lens holder 2, the intermediate member 3, and the support 8 when the intermediate member 3 (with the lens holder 2) is moved toward the Z1 side with respect to the support 8 by the first wire SA1 and the fifth wire SA5. Furthermore, FIG. 13 illustrates the positional relationship of the lens holder 2, the intermediate member 3, and the support 8 when the lens holder 2 is moved toward the Z1 side with respect to the intermediate member 3 by the second wire SA2 and the sixth wire SA6. In the following description referring to FIGS. 11 to 13, the movement by the first wire SA1 and the fifth wire SA5 and the movement by the second wire SA2 and the sixth wire SA6 are performed separately in order to make the description easier to understand, but in reality, the movement by the first wire SA1 and the fifth wire SA5 and the movement by the second wire SA2 and the sixth wire SA6 are performed simultaneously. Therefore, the lens holder 2 does not substantially rotate about the optical-axis OA.

When the first wire SA1 and the fifth wire SA5 contract by a predetermined amount, the intermediate member 3 rotates counterclockwise about the optical-axis OA by an angle α in the top view as indicated by an arrow AR1 in the upper diagram of FIG. 12, and moves along the optical-axis direction by a distance ST1 to the Z1 side as indicated by the Z-axis component of the arrow AR1 in the lower diagram of FIG. 12. The arrow AR1 in the lower diagram of FIG. 12 is decomposed into a component in the Z-axis direction and a component in the circumferential direction of a circle about the optical-axis OA.

In the upper and lower diagrams of FIG. 12, the positions (outlines) of the lens holder 2 and the intermediate member 3 in the state as illustrated in FIG. 11 are represented by dashed lines, and in the upper diagram of FIG. 12, the first wire SA1 and the fifth wire SA5 are represented by thick dotted lines.

At this time, the controller performs control such that a predetermined current is supplied not only to the first wire SA1 and the fifth wire SA5, but also to the third wire SA3 and the seventh wire SA7, whose one end is fixed to the support 8, such that the intermediate member 3 does not incline with respect to the optical-axis OA and the position of the optical-axis OA on the XY-plane does not shift.

When the intermediate member 3 rotates counterclockwise about the optical-axis OA by an angle α in the top view and moves by a distance ST1 on the Z1 side along the optical-axis direction, the lens holder 2 connected to the intermediate member 3 via four shape-memory alloy wires SA (second wire SA2, fourth wire SA4, sixth wire SA6, and eighth wire SA8), together with the intermediate member 3, rotates counterclockwise about the optical-axis OA by the angle α in the top view as indicated by an arrow AR2 in the upper diagram of FIG. 12, and moves by the distance ST1 on the Z1 side along the optical-axis direction as indicated by the component in the Z-axis direction of the arrow AR2 in the lower diagram of FIG. 12. The arrow AR2 in the lower diagram of FIG. 12 is decomposed into a component in the Z-axis direction and a component in the circumferential direction of a circle about the optical-axis OA.

When the second wire SA2 and the sixth wire SA6 contract by a predetermined amount, the lens holder 2 rotates clockwise about the optical-axis OA by an angle β in the top view as indicated by an arrow AR3 in the upper diagram of FIG. 13, and moves by a distance ST2 on the Z1 side along the optical-axis direction as indicated by a component in the Z-axis direction of the arrow AR3 in the lower diagram of FIG. 13. The arrow AR3 in the lower diagram of FIG. 13 is decomposed into a component in the Z-axis direction and a component in the circumferential direction of a circle about the optical-axis OA.

In the upper and lower diagrams of FIG. 13, the position (outline) of the lens holder 2 in the state as illustrated in FIG. 12 is represented by a broken line, and in the upper diagram of FIG. 13, the second wire SA2 and the sixth wire SA6 are represented by thick dotted lines. Moreover, in the illustrated example, the angle β has the same size as the angle α.

At this time, the controller performs control such that a predetermined current is supplied not only to the second wire SA2 and the sixth wire SA6 but also to the fourth wire SA4 and the eighth wire SA8, whose one end is fixed to the lens holder 2, such that the lens holder 2 does not incline with respect to the optical-axis OA and that the position of the optical-axis OA on the XY-plane does not shift.

Therefore, when the first wire SA1, the second wire SA2, the fifth wire SA5, and the sixth wire SA6 contract by a predetermined amount, the lens holder 2 does not incline relative to the optical-axis OA and moves along the optical-axis Z1 side by the total distance of the distance ST1 and the distance ST2. In contrast to this, the counterclockwise rotation of the lens holder 2 about the optical-axis OA by the amount of the angle α and the clockwise rotation of the lens holder 2 about the optical-axis OA by the amount of the angle β cancel each other, and the lens holder 2 does not rotate about the optical-axis OA when the angle α and the angle β are the same size.

In the example as illustrated in FIGS. 11 to 13, the controller is configured to translate the lens holder 2 toward the Z1 side without rotation about the optical-axis OA by contracting the four shape-memory alloy wires SA (the first wire SA1, the second wire SA2, the fifth wire SA5, and the sixth wire SA6). However, the controller may be configured to translate the lens holder 2 toward the Z1 side without rotation about the optical-axis OA by contracting the two shape-memory alloy wires SA (the first wire SA1 and the second wire SA2). In this case, the controller performs control such that a predetermined current is supplied not only to the first wire SA1 and the second wire SA2 but also to other shape-memory alloy wires SA (the third wire SA3 to the eighth wire SA8) such that the lens holder 2 does not incline with respect to the optical-axis OA and the position of the optical-axis OA on the XY-plane does not shift.

The above description referring to FIGS. 11 to 13 mainly relates to the case where the first wire SA1, the second wire SA2, the fifth wire SA5, and the sixth wire SA6 are contracted to move the lens holder 2 and the intermediate member 3 to the upper side (Z1 side), but the above description similarly applies to the case where the third wire SA3, the fourth wire SA4, the seventh wire SA7, and the eighth wire SA8 are contracted to move the lens holder 2 and the intermediate member 3 to the lower side (Z2 side).

As described above, the lens drive device 101, which is an example of the optical element drive device according to the embodiment of the present disclosure, includes, as illustrated in FIG. 2, the support 8, the optical element holder (lens holder 2) including the opening 2K in which the optical element (lens body LS) can be arranged and that is movable in a predetermined direction (optical-axis direction) along a predetermined axis (optical-axis OA) with respect to the support 8, the driver DM including shape-memory alloy wires SA configured to move the lens holder 2 in the optical-axis direction, and the intermediate member 3 provided between the lens holder 2 and the support 8. The intermediate member 3 is movable relative to the support 8 and movable relative to the lens holder 2. The shape-memory alloy wires SA include the first wire SA1 provided between the support 8 and the intermediate member 3, and the second wire SA2 provided between the intermediate member 3 and the lens holder 2. In the first wire SA1, one end supported by the support 8 is arranged at a higher position than the other end supported by the intermediate member 3. In the second wire SA2, one end supported by the intermediate member 3 is arranged at a higher position than the other end supported by the lens holder 2. When current is applied to the first wire SA1 and the second wire SA2, rotation of the lens holder 2 about the optical-axis OA is suppressed by contraction of the first wire SA1 and contraction of the second wire SA2, and the lens holder 2 moves in the optical-axis direction.

This configuration can suppress rotation of the lens holder 2 about the optical-axis OA when the lens holder 2 is moved along the optical-axis OA. Therefore, this configuration has the effect that image quality is not appreciably affected even when the number of pixels of the imaging sensor IS increases. Moreover, this configuration can move the intermediate member 3 along one side of the optical-axis direction with respect to the support 8, and can move the lens holder 2 along one side of the optical-axis direction with respect to the intermediate member 3. Therefore, this configuration can increase the amount of movement of the lens holder 2 in the optical-axis direction as compared with the configuration in which only the lens holder 2 or the intermediate member 3 is moved with respect to the support 8.

Furthermore, as illustrated in FIG. 7, the first wire SA1 and the second wire SA2 are preferably provided at positions facing each other across the opening 2K of the lens holder 2 in the first direction (Y-axis direction) crossing the optical-axis direction (Z-axis direction).

In this configuration, weight balance of the lens drive device 101 can be enhanced as compared with the configuration in which the first wire SA1 and the second wire SA2 are respectively provided at positions not facing each other across the opening 2K of the lens holder 2, and the rotation of the lens holder 2 about the optical-axis OA can be appropriately suppressed.

In addition, as illustrated in FIG. 7, the shape-memory alloy wires SA preferably include: the first wire SA1 and the second wire SA2 respectively arranged at positions facing each other across the opening 2K of the lens holder 2 in the first direction (Y-axis direction); the third wire SA3 and the fourth wire SA4 respectively arranged at positions facing each other across the opening 2K of the lens holder 2 in a second direction (X-axis direction) crossing the optical-axis direction and perpendicular to the first direction (Y-axis direction); the fifth wire SA5 and the sixth wire SA6 respectively arranged at positions facing each other across the opening 2K of the lens holder 2 in the first direction (Y-axis direction); and the seventh wire SA7 and the eighth wire SA8 respectively arranged at positions facing each other across the opening 2K of the lens holder 2 in the second direction (X-axis direction). The first wire SA1 is provided between the support 8 and the intermediate member 3, and one end of the first wire SA1 supported by the support 8 is arranged at a higher position than the other end supported by the intermediate member 3; the second wire SA2 is provided between the intermediate member 3 and the lens holder 2, and one end of the second wire SA2 supported by the intermediate member 3 is arranged at a higher position than the other end supported by the lens holder 2; the third wire SA3 is provided between the support 8 and the intermediate member 3, and one end of the third wire SA3 supported by the support 8 is arranged at a lower position than the other end supported by the intermediate member 3; and the fourth wire SA4 is provided between the intermediate member 3 and the lens holder 2, and one end of the fourth wire SA4 supported by the intermediate member 3 is arranged at a lower position than the other end supported by the lens holder 2; the fifth wire SA5 is provided between the support 8 and the intermediate member 3, and one end of the fifth wire SA5 supported by the support 8 is arranged at a higher position than the other end supported by the intermediate member 3; the sixth wire SA6 is provided between the intermediate member 3 and the lens holder 2, and one end of the sixth wire SA6 supported by the intermediate member 3 is arranged at a higher position than the other end supported by the lens holder 2; the seventh wire SA7 is provided between the support 8 and the intermediate member 3, and one end of the seventh wire SA7 supported by the support 8 is arranged at a lower position than the other end supported by the intermediate member 3; and the eighth wire SA8 is provided between the intermediate member 3 and the lens holder 2, and one end of the eighth wire SA8 supported by the intermediate member 3 is arranged at a lower position than the other end supported by the lens holder 2. As illustrated in the right side view in FIG. 8, when viewed along the first direction (Y-axis direction), the first wire SA1 and the fifth wire SA5 are arranged to cross each other, and the second wire SA2 and the sixth wire SA6 are arranged to cross each other. Additionally, as illustrated in the front view in FIG. 8, when viewed along the second direction (X-axis direction), the third wire SA3 and the seventh wire SA7 are arranged to cross each other, and the fourth wire SA4 and the eighth wire SA8 are arranged to cross each other.

This configuration has the effect that the rotation of the lens holder 2 about the optical-axis OA can be suppressed no matter which direction the lens holder 2 is moved in the optical-axis direction, that is, whether the lens holder 2 is moved upward or downward.

Preferably, as illustrated in FIG. 7, one end of each of the first wire SA1, third wire SA3, fifth wire SA5, and seventh wire SA7 is fixed to a corresponding one of the metal members 5 (support-side metal members 5F (second support-side metal member 5F2, first support-side metal member 5F1, fourth support-side metal member 5F4, and third support-side metal member 5F3)) fixed to the support 8. The other end of each of the first wire SA1, third wire SA3, fifth wire SA5, and seventh wire SA7 is fixed to a corresponding one of the metal members 5 (intermediate metal members 5M (eighth intermediate metal member 5M8, first intermediate metal member 5M1, fourth intermediate metal member 5M4, and fifth intermediate metal member 5M5)) fixed to the intermediate member 3. One end of each of the second wire SA2, fourth wire SA4, sixth wire SA6, and eighth wire SA8 is fixed to a corresponding one of the metal members 5 (intermediate metal members 5M (second intermediate metal member 5M2, seventh intermediate metal member 5M7, sixth intermediate metal member 5M6, and third intermediate metal member 5M3)) fixed to the intermediate member 3. The other end of each of the second wire SA2, fourth wire SA4, sixth wire SA6, and eighth wire SA8 is fixed to a corresponding one of the metal members 5 (lens-side metal members 5L (fourth lens-side metal member 5L4, third lens-side metal member 5L3, second lens-side metal member 5L2, and first lens-side metal member 5L1)) fixed to the lens holder 2. As illustrated in the top view in FIG. 8, each of the metal members 5 is formed of a metal plate including a plate-like base portion BP, and is fixed to the corresponding member with the plate surface of the base portion BP substantially perpendicular to the optical-axis OA.

Since all (16 in total) metal members 5 can be attached to the corresponding members from one side (Z1 side, top), this configuration has the effect that the productivity (manufacturability) of the lens drive device 101 can be enhanced as compared with the configuration in which the metal members 5 need to be attached from at least two sides.

Furthermore, as illustrated in the top view in FIG. 8, the respective metal members 5 are preferably arranged in positions which do not overlap with each other in the top view along the optical-axis direction.

Since all (16 in total) metal members 5 can be attached from one side (Z1 side, top) in any order, this configuration has the effect that the productivity (manufacturability) of the lens drive device 101 can be enhanced as compared with the configuration in which at least some of the metal members 5 are arranged at the same position while overlapping with each other, that is, a configuration in which the order of attachment is limited.

Furthermore, as illustrated in FIG. 7, the lens drive device 101 preferably includes a plate spring 6 connecting the lens holder 2 and the support 8.

This configuration has the effect that the lens holder 2 can be centered in the XY-plane with respect to each of the intermediate member 3 and the support 8.

Preferably, as illustrated in the top view in FIG. 8, in the top view in the optical-axis direction, a distance DS1 between one end of the first wire SA1 and the other end of the first wire SA1 is longer than a distance DS2 between one end of the second wire SA2 and the other end of the second wire SA2. In other words, in the top view in the optical-axis direction, the shape-memory alloy wires SA (first wire SA1, third wire SA3, fifth wire SA5, and seventh wire SA7) arranged at positions having a farther distance to the optical-axis OA are longer than the shape-memory alloy wires SA (second wire SA2, fourth wire SA4, sixth wire SA6, and eighth wire SA8) arranged at positions having a closer distance to the optical-axis OA.

In this configuration, space efficiency inside the housing HS can be enhanced as compared with the configuration in which the shape-memory alloy wires SA arranged at positions having a farther distance to the optical-axis OA are shorter than the shape-memory alloy wires SA arranged at positions having a closer distance to the optical-axis OA, in the top view in the optical-axis direction.

Preferably, as illustrated in the right side view in FIG. 8, a distance HT1 in the optical-axis direction between one end of the first wire SA1 and the other end is longer than a distance HT2 in the optical-axis direction between one end of the second wire SA2 and the other end. In other words, in the side view in the X-axis direction or the Y-axis direction, each of the plurality of shape-memory alloy wires SA is arranged to incline by the same angle (inclination angle) with respect to the XY-plane.

In comparison with the case where the inclination angles of the plurality of shape-memory alloy wires SA differ greatly from each other, this configuration provides the effect that the movable-side member MB can be stably moved. In addition, this configuration has the effect that the amount of movement along the optical-axis direction can be increased as compared with the case where the inclination angle of each of the plurality of shape-memory alloy wires SA is small.

The optical element drive device can suppress rotation of the optical element about the predetermined axis when the optical element is moved along the predetermined axis.

The above described preferred embodiments of the present invention have been described in detail. However, the present invention is not limited to the above-described embodiments. The above-described embodiments and the embodiments described in the following can be applied with various modifications, substitutions, and the like without departing from the scope of the present invention. Each of the features described with reference to the above-described embodiments and the embodiments described in the following may be appropriately combined as long as they are not technically inconsistent.

For example, in the above-described embodiments, each of the metal members 5 is fixed to the corresponding member (the lens holder 2, the intermediate member 3, or the support 8) by an adhesive or the like, but may be embedded in the member or may be provided as a conductive pattern formed on the surface of each member.

What is claimed is:

1. An optical element drive device comprising:
a support;
an optical element holder provided with an opening capable of disposing therein an optical element and configured to move in a predetermined direction along a predetermined axis relative to the support;
a driver including a shape-memory alloy wire to move the optical element holder in the predetermined direction; and
an intermediate member provided between the optical element holder and the support, wherein
the intermediate member is movable relative to the support and movable relative to the optical element holder,
the shape-memory alloy wire includes a first wire provided between the support and the intermediate member, and a second wire provided between the intermediate member and the optical element holder,
the first wire has one end supported by the support at a higher position than another end supported by the intermediate member,
the second wire has one end supported by the intermediate member at a higher position than another end supported by the optical element holder, and
the optical element holder moves in the predetermined direction by suppressing rotation about the predetermined axis by generating contraction of the first wire and contraction of the second wire upon applying a current to the first wire and the second wire.

2. The optical element drive device according to claim 1, wherein
the first wire and the second wire are provided at positions facing each other across the opening of the optical element holder in a first direction crossing the predetermined direction.

3. The optical element drive device according to claim 1, wherein
shape-memory alloy wires, each being the shape-memory alloy wire, include a third wire and a fourth wire respectively arranged at positions facing each other across the opening of the optical element holder in a second direction crossing the predetermined direction and perpendicular to the first direction, a fifth wire and a sixth wire respectively arranged at positions facing each other across the opening of the optical element holder in the first direction, and a seventh wire and an eighth wire respectively arranged at positions facing each other across the opening of the optical element holder in the second direction,
the third wire is provided between the support and the intermediate member, and one end of the third wire supported by the support is arranged at a lower position than another end supported by the intermediate member,
the fourth wire is provided between the intermediate member and the optical element holder, and one end of the fourth wire supported by the intermediate member is arranged at a lower position than another end supported by the optical element holder,
the fifth wire is provided between the support and the intermediate member, and one end of the fifth wire supported by the support is arranged at a higher position than another end supported by the intermediate member,
the sixth wire is provided between the intermediate member and the optical element holder, and one end of the sixth wire supported by the intermediate member is arranged at a higher position than another end supported by the optical element holder,
the seventh wire is provided between the support and the intermediate member, and one end of the seventh wire supported by the support is arranged at a lower position than another end supported by the intermediate member;
the eighth wire is provided between the intermediate member and the optical element holder, and one end of the eighth wire supported by the intermediate member is arranged at a lower position than another end supported by the optical element holder,
upon viewing along the first direction, the first wire and the fifth wire are arranged to cross each other, and the second wire and the sixth wire are arranged to cross each other, and
upon viewing along the second direction, the third wire and the seventh wire are arranged to cross each other, and the fourth wire and the eighth wire are arranged to cross each other.

4. The optical element drive device according to claim 3, wherein
the one end of each of the first wire, the third wire, the fifth wire, and the seventh wire is fixed to a corresponding one of metal members fixed to the support,
the another end of each of the first wire, the third wire, the fifth wire, and the seventh wire is fixed to a corresponding one of the metal members fixed to the intermediate member,
the one end of each of the second wire, the fourth wire, the sixth wire, and the eighth wire is fixed to a corresponding one of the metal members fixed to the intermediate member,
the another end of each of the second wire, the fourth wire, the sixth wire, and the eighth wire is fixed to a corresponding one of the metal members fixed to the optical element holder, and
each of the metal members is formed of a metal plate including a base portion having a plate-like shape, and is fixed to a corresponding member with a plate surface of the base portion substantially perpendicular to the predetermined axis.

5. The optical element drive device according to claim 4, wherein
each of the metal members is arranged in a position which does not overlap with any other of the metal members in a top view along the predetermined direction.

6. The optical element drive device according to claim 1, further comprising:
a plate spring connecting the optical element holder and the support.

7. The optical element drive device according to claim 1, wherein
in a top view along the predetermined direction, a distance between the one end of the first wire and the another end of the first wire is longer than a distance between the one end of the second wire and the another end of the second wire.

8. The optical element drive device according to claim 1, wherein
a distance between the one end of the first wire and the another end of the first wire in the predetermined direction is longer than a distance between the one end of the second wire and the another end of the second wire in the predetermined direction.

9. A camera module, comprising:
the optical element drive device according to claim 1;
a lens body fixed to the optical element holder; and
an imaging sensor that faces the lens body.
